(19) United States
(12) Patent Application Publication
(10) Pub. No.: US 2010/0286018 A1
(43) Pub. Date: Nov. 11, 2010

(54) SCENT-COMPRISING MICROCAPSULES WITH IMPROVED RELEASE BEHAVIOR

(75) Inventors: Hans-Peter Hentze, Espoo (FI); Marc Rudolf Jung, Worms (DE); Tobias Joachim Koplin, Ludwigshafen (DE); Juergen Detering, Limburgerhof (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/812,325

(22) PCT Filed: Jan. 13, 2009
(86) PCT No.: PCT/EP09/50319

§ 371 Date: Jul. 9, 2010

(30) Foreign Application Priority Data
Jan. 15, 2008 (EP) 08100495.4

(51) Int. Cl. C11D 3/50; C11D 17/00

(52) U.S. Cl. 510/299; 512/4; 510/349

(57) ABSTRACT

The present invention relates to microcapsules, microcapsule preparations, and detergents and cleaners comprising these, where the microcapsules comprise, in their core, one or more scents or fragrance(s) whose release behavior from the core of the microcapsules is considerably slowed through the use of more than one crosslinker.

The present invention relates to microcapsules, microcapsule preparations, and mixtures comprising these, in particular detergents and cleaners, where the microcapsules comprise, in their core, one or more scents or fragrance(s) whose release behavior from the core of the microcapsules is considerably slowed through the use of more than one crosslinker.

Most detergent and cleaner compositions comprise scents or fragrances in order to impart a pleasant scent to the compositions themselves or to the textiles or surfaces treated therewith. The scents or fragrances are mostly compounds with a plurality of conjugated double bonds which are more or less sensitive toward different chemicals or oxidation. It is therefore possible for undesired interactions with other ingredients of the detergents or cleaners, such as, for example, surfactants or bleaches, to occur, as a result of which the scent or fragrance is decomposed and/or changes the odor note. A further problem is the sometimes high volatility of the scents or fragrances, which leads to a large part of the amount of scent or fragrance originally added to the detergent or cleaner having already evaporated before the time of use. To overcome the discussed problems, it has already been proposed to incorporate the scents or fragrances into the detergents or cleaners in microencapsulated form. Microcapsules of this type have already been described:

WO 01/49817 (BASF) describes microcapsule preparations comprising microcapsules with a core of a hydrophobic material, which comprises at least one scent or fragrance, and a shell which is obtainable by free-radical polymerization of ethylenically unsaturated monomers which comprise: 30 to 100% by mass of one or more C₁-C₂₄ alkyl esters of acrylic acid and/or methacrylic acid, 0 to 70% by mass of a bi- or polyfunctional monomer, 0 to 40% by mass of other monomers, and also detergent and cleaner compositions which comprise these microcapsules.

WO 05/105291 (Ciba) describes, inter alia, scent- and fragrance-comprising microcapsules whose shell is constructed by free-radical polymerization of a mixture of 10 to 75% of water-soluble vinylic monomers, 10 to 75% of a di- or polyfunctional vinylic monomer and 10 to 50% of further vinylic monomers.

WO 93/02144 (BASF) describes microcapsules with a hydrophobic core which comprises a scent or fragrance. In this case, the shell is obtained by free-radical polymerization of at least 1% by mass ionogenic monomers and/or ethylenically polyunsaturated monomers, where at least one of the bonds is basically or acidically hydrolyzable.

U.S. Pat. No. 4,798,691 (Japan Synthetic Rubber) likewise discloses microcapsules which can have a hydrophobic core and have a shell which is obtainable through a mixture of monomer and a crosslinkable monomer.

However, all of these microcapsules have the disadvantage that their shells are either too permeable for the scents or fragrances or that the shells are so stable that the scent or fragrance is barely released, or not released at all, upon normal mechanical stress. The object of the present invention is therefore to provide microcapsules comprising scents or fragrances for which the mechanical stability of the microcapsules and the retention capacity of the shell for the scents and fragrances located in the core is selected such that, compared with the prior art, an improved retention and release capacity of the scents and fragrances is achieved. This means that, firstly, the release of the scents or fragrances should take place over a prolonged period and simultaneously a “burst release” effect following capsule rupture as a result of rubbing is also ensured over a prolonged period.

This object is surprisingly achieved by microcapsules according to claims 1 to 6. The chemical composition according to claims 7 and 8, the uses according to claims 9 to 12, and the subject matters according to claims 13 and 14 form further subject matters of the present invention.

The present invention provides a

microcapsule comprising a core a), which comprises a scent or fragrance, and a shell b), where b) is obtainable by polymerization of
one or more C₁-C₂₄-alkyl ester(s) of acrylic acid and/or methacrylic acid and
at least two different bi- or polyfunctional monomers.

In this connection, preference is given to certain embodiments. Thus, preference is given to a microcapsule in which, independently of one another,
a) comprises at least one hydrophobic material,
b) can be prepared by free-radical polymerization,
the amount of C₁-C₂₄-alkyl ester(s) of acrylic acid and/or methacrylic acid in the microcapsule is 1 to 99.99% by mass,
a C₁-C₁₈-alkyl ester(s) of acrylic acid and/or methacrylic acid is present,
the amount of the at least two different bi- or polyfunctional monomers in the microcapsule is 0.01 to 70% by mass,
two, three, four or five different bi- or polyfunctional monomers are present,
the amount of monofunctional monomers which have additional nonvinylic functional groups in the microcapsule is 0 to 50% by mass, and
further monofunctional monomers which have additional nonvinylic functional groups are present in an amount of from 0 to 40% by mass in the microcapsule.

Particular preference is given to a microcapsule in which, independently of one another,
a) consists of the at least one hydrophobic material and the at least one scent or fragrance or
   a) consists of the at least one scent or fragrance,
b) is prepared by free-radical polymerization,
the amount of C₁-C₂₄-alkyl ester(s) of acrylic acid and/or methacrylic acid in the microcapsule is 20 to 80% by mass,
a C₁-C₁₂-alkyl ester of acrylic acid and/or methacrylic acid is present,
the amount of the at least two different bi- or polyfunctional monomers in the microcapsule is 5 to 50% by mass,
two or three different bi- or polyfunctional monomers are present,
the amount of monofunctional monomers which have additional nonvinylic functional groups in the microcapsule is 10 to 40% by mass, and
further monofunctional monomers which have additional nonvinylic functional groups are present in the microcapsule in an amount of from 5 to 35% by mass.

Very particular preference is given to a microcapsule in which, independently of one another,
the at least one hydrophobic material is selected from the group consisting of: vegetable oil, animal oil, and mineral oil,
the at least one scent or fragrance is selected from the group consisting of: natural scents or fragrances, synthetic scents or fragrances and semisynthetic scents or fragrances,
the amount of C₁-C₂₄-alkyl ester(s) of acrylic acid and/or methacrylic acid in the microcapsule is 35 to 60% by mass,
a C₁-C₆-alkyl ester of acrylic acid and/or methacrylic acid is present, the amount of the at least two different bi- or polyfunctional monomers in the microcapsule is 20 to 40% by mass,
two different bi- or polyfunctional monomers are present,
the amount of monofunctional monomers which have additional nonvinylic functional groups in the microcapsule is 20 to 30% by mass, and
further monofunctional monomers which have additional nonvinylic functional groups are present in the microcapsule in an amount of from 10 to 30% by mass.

C₁-C₂₄-Alkyl ester(s) of acrylic acid and/or methacrylic acid are understood generally as meaning not only the pure alkyl esters, but also modified compounds, such as alkylamides of acrylic acid or vinyl alkyl ethers. Nonexhaustive examples are: tent butylacrylamide and acrylamide.

Furthermore, bi- or polyfunctional monomers are understood as meaning substances which have more than one free-radically polymerizable group and thus can join together the polymer chains that grow during polymerization to give a three-dimensional network. Here, besides the polyfunctional monomers, it is also possible to use oligomeric crosslinkers.

Nonexhaustive examples are: butanediol diacrylate, dipropylene glycol diacrylate, hexanediol diacrylate, ethoxylated trimethylolpropane triacrylate, tripropylene glycol diacrylate, 2,5-dimethyl-2,5-hexanediol dimethacrylate, particular preference being given here to: butanediol diacrylate, pentaerythritol tetraacrylate and pentaerythritol triacrylate.

The hydrophobic materials which can be used as core material include all types of oils, such as vegetable oils, animal oils, mineral oils, paraffins, chloroparaffins, fluorinated hydrocarbons and other synthetic oils.

Typical and nonexhaustive examples are sunflower oil, rapeseed oil, olive oil, peanut oil, soya oil, kerosene, benzene, toluene, butane, pentane, hexane, cyclohexane, chloroform, tetrachloromethane, chlorinated diphenyls and silicone oil. It is also possible to use hydrophobic materials with a high boiling point, e.g. diethyl phthalate, dibutyl phthalate, diisohexyl phthalate, dioctyl phthalate, alkylnaphthalene, dodecylbenzene, terphenyl, partially hydrogenated terphenyls, ethylhexyl palmitates, caprylic/capric triglycerides, PPG-2 myristyl ether propionates; PPG-5 ceteth-20; C₁₂₋₁₅-alkyl benzoates, mineral oil (CAS: 8042-47-5); cetearyl ethylhexanoates; dimethicones; polyisobutylenes (e.g. BASF: Glisopal®, Oppanol®).

The hydrophobic material if appropriate comprising the scent or fragrance, or consisting thereof, is selected such that it can be emulsified in water at temperatures between its melting point and the boiling point of water. Low-viscosity hydrophobic materials here have a Brookfield viscosity of <5 Pa*s (measured at 23° C. using a size 5 spindle and 20 rpm in accordance with DIN EBN ISO 3219).

A scent or fragrance is understood as meaning all organic substances which have a desired olfactory property and are essentially nontoxic. These include, inter alia, all scents or fragrances customarily used in detergent or cleaner compositions or in perfumery. They may be compounds of natural, semisynthetic or synthetic origin. Preferred scents or fragrances can be assigned to the hydrocarbon, aldehyde or ester classes of substance. The scents or fragrances also include natural extracts and/or essences which can comprise complex mixtures of constituents, such as orange oil, lemon oil, rose extract, lavender, musk, patchouli, balsam essence, sandalwood oil, pine oil and cedar oil.

Nonlimiting examples of synthetic and semisynthetic scents or fragrances are: 7-acetyl-1,2,3,4,5,6,7,8-octahydro-1,1,6,7-tetramethylnaphthalene, α-ionone, β-ionone, γ-ionone, α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl β-naphthyl ketone, 6-acetyl-1,1,2,3,3,5-hexamethylindane, 5-acetyl-3-isopropyl-1,1,2,6-tetramethylindane, 1-dodecanal, 4-(4-hydroxy-4-methylpentyl)-3-cyclohexene-1-carboxaldehyde, 7-hydroxy-3,7-dimethyloctanal, 10-undecen-1-al, isohexenylcyclo-hexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl)propionaldehyde, ethylvanillin, heliotropin, hexylcinnamaldehyde, amylcinnamaldehyde, 2-methyl-2-(isopropylphenyl)propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-γ-2-benzopyran, β-naphthol methyl ether, ambroxan, dodecahydro-3a,6,6,9a-tetramethylnaphtho[2,lb]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate and tent-butyl-cyclohexyl acetate.

Particular preference is given to: hexylcinnamaldehyde, 2-methyl-3-(tert-butylphenyl)-propionaldehyde, 7-acetyl-1,2,3,4,5,6,7,8-octahydro-1,1,6,7-tetramethylnaphthalene, benzyl salicylate, 7-acetyl-1,1,3,4,4,6-hexamethyltetralin, para-terbutyl-cyclohexyl acetate, methyl dihydrojasmonate, β-naphthol methyl ether, methyl 3-naphthyl ketone, 2-methyl-2-(para-isopropylphenyl)propionaldehyde, 1,3,4,6,7,8-hexahydro-4,6,6,7,8,8-hexamethylcyclopenta-γ-2-benzopyran, dodecahydro-3a,6,6,9a-tetramethylnaphtho[2,1b]furan, anisaldehyde, coumarin, cedrol, vanillin, cyclopentadecanolide, tricyclodecenyl acetate and tricyclodecenyl propionates.

Other scents are essential oils, resinoids and resins from a large number of sources, such as Peru balsam, olibanum resinoid, styrax, labdanum resin, nutmeg, cassia oil, benzoin resin, coriander and lavandin. Further suitable scents are: phenylethyl alcohol, terpineol, linalool, linalyl acetate, geraniol, nerol, 2-(1,1-dimethylethyl)-cyclohexanol acetate, benzyl acetate and eugenol.

The scents or fragrances can be used as pure substances or in a mixture with one another. The scent or fragrance may, as the sole hydrophobic material, form the core of the microcapsules. Alternatively, the microcapsules may in addition to the scent or fragrance comprise a further hydrophobic material in which the scent or fragrance is dissolved or dispersed. Thus, for example, when using scents or fragrances that are solid at room temperature, the use of a hydrophobic material that is liquid at room temperature, in the form of a solution or dispersant, is advantageous.

Similarly, a further hydrophobic material may be added to the scent or fragrance in order to increase its hydrophobicity.

The scent or fragrance, or the mixture of scents or fragrances, preferably constitutes 1 to 100% by mass, preferably 20 to 100% by mass, of the hydrophobic core material. The hydrophobic material is liquid at temperatures below 100° C., preferably at temperatures below 60° C. and particularly preferably at room temperature.

In one embodiment of the invention, the shell of the microcapsules is produced by polymerization of ethylenically unsaturated monomers. The shell is produced by polymerization of 30 to 100% by mass, preferably 30 to 95% by mass (in each case based on the total mass of the monomers in the shell), of one or more C₁-C₂₄-alkyl esters, preferably one or more C₁-C₁₈-alkyl esters, particularly preferably one or more C₁-C₁₂-alkyl esters and very particularly preferably one or more C₁-C₄-alkyl esters, of acrylic acid and/or methacrylic acid. These are, for example, methyl acrylate, methyl methacrylate, ethyl acrylate, ethyl methacrylate, n-propyl acrylate, n-propyl methacrylate, isopropyl acrylate, isopropyl methacrylate, n-butyl acrylate, iso-butyl acrylate, tert-butyl acrylate, n-butyl methacrylate, isobutyl methacrylate, tertbutyl methacrylate, cyclohexyl acrylate, cyclohexyl methacrylate, octyl acrylate, octyl methacrylate, 2-ethylhexyl acrylate, 2-ethylhexyl methacrylate, lauryl acrylate, lauryl methacrylate, stearyl acrylate and palmityl acrylate.

0 to 70% by mass, preferably 5 to 40% by mass (in each case based on the total mass of the monomers in the shell), of the shell are formed by a mixture of at least two bi- or polyfunctional monomers, i.e. ethylenically di- or polyunsaturated compounds. These are, for example, acrylic acid and methacrylic acid esters derived from dihydric C₂-C₂₄-alcohols, e.g. ethylene glycol diacrylate, propylene glycol diacrylate, ethylene glycol dimethacrylate, propylene glycol dimethacrylate, 1,4-butanediol diacrylate, 1,4-butanediol dimethacrylate, 1,6-hexanediol diacrylate and 1,6-hexanediol dimethacrylate, and divinylbenzene, methallylmethacrylamide, allyl methacrylate, allyl acrylate, methylenebisacrylamide, trimethylolpropane triacrylate, trimethylolpropane trimethacrylate, pentaerythritol triallyl ether, pentaerythritol tetraacrylate and pentaerythritol tetramethacrylate.

0 to 40% by mass, preferably 0 to 30% by mass, of the shell can be composed of other monomers. These include, in particular, vinylaromatic compounds, such as styrene and α-methylstyrene, vinylpyridine, vinyl esters of C₁-C₂₀-carboxylic acids, such as vinyl acetate, vinyl propionate, methacrylonitrile, methacrylamide, N-methylmethacrylamide, dimethylaminopropylmethacrylamide, dimethylaminoethyl acrylate, dimethylamino-methacrylate, vinylcyclohexane, vinyl chloride, vinylidene chloride, 2-hydroxypropyl acrylate, methacrylic acid and 2-hydroxypropyl methacrylate.

The microcapsules are obtainable by polymerization of the monomer or monomer mixture forming the shell in the oil phase of a stable oil-in-water emulsion, where the oil phase consists of the aforementioned hydrophobic material. Before the start of the polymerization, a mixture of monomers and hydrophobic phase must be present which comprises at least one scent or fragrance. This production method is known per se and described, for example, in EP-A-0 457 154.

The core of the microcapsules is formed by the water-emulsifiable hydrophobic material. The hydrophobic material serves simultaneously as solvent or dispersant for the monomer mixture used in the production of the capsule sheath through polymerization. The polymerization then takes place in the oil phase of a stable oil-in-water emulsion. This emulsion is obtained by, for example, firstly dissolving the monomers and a polymerization initiator and, if appropriate, a polymerization regulator in the hydrophobic material, and emulsifying the solution obtained in this way in an aqueous medium with an emulsifier and/or protective colloid. However, it is also possible to firstly emulsify the hydrophobic phase or constituents thereof in the aqueous phase and then to add the monomers or the polymerization initiator and the auxiliaries that are, if appropriate, still also to be used, such as protective colloids or polymerization regulators, to the emulsion.

In another process variant, it is also possible to emulsify the hydrophobic material and the monomers in water and then to add only the polymerization initiator. Since the hydrophobic material should be microencapsulated as completely as possible in the emulsion, preference is given to using only those hydrophobic materials whose solubility in water is limited. The solubility should preferably not exceed 5% by weight. For one complete encapsulation of the hydrophobic material in the oil phase of the oil-in-water emulsion, it is expedient to select the monomers according to their solubility in the hydrophobic material. While the monomers are essentially soluble in the oil, from these are formed, during the polymerization in the individual oil droplets, oligomers and polymers which are soluble neither in the oil phase nor in the water phase of the oil-in-water emulsion and migrate to the interface between the oil droplets and the water phase. There, in the course of further polymerization, they form the wall material, which ultimately surrounds the hydrophobic material as core of the microcapsules.

Protective colloids and/or emulsifiers are generally used for forming a stable oil-in-water emulsion. Suitable protective colloids are, for example, cellulose derivatives, such as hydroxyethylcellulose, carboxymethylcellulose and methylcellulose, polyvinylpyrrolidone and copolymers of N-vinylpyrrolidone, polyvinyl alcohols and partially hydrolyzed polyvinyl acetates. Particular preference is given here to the polyvinyl alcohols. In addition, it is also possible to use gelatin, gum arabic, xanthan gum, alginates, pectins, degraded starches and casein. Ionic protective colloids can also be used. Ionic protective colloids that can be used are polyacrylic acid, polymethacrylic acid, copolymers of acrylic acid and methacrylic acid, water-soluble polymers containing sulfonic acid groups and having a content of sulfoethyl acrylate, sulfoethyl methacrylate or sulfopropyl methacrylate, and polymers of N-(sulfoethyl)-maleimide, 2-acrylamido-2-alkylsulfonic acids, styrenesulfonic acids and formaldehyde, and also condensates of phenolsulfonic acids and formaldehyde. The protective colloids are generally added in amounts of from 0.1 to 10% by mass, based on the water phase of the emulsion. The polymers used as ionic protective colloids preferably have average molar masses M_{w} of from 500 to 1 000 000 g/mol, preferably 1000 to 500 000 g/mol.

The polymerization generally takes place in the presence of polymerization initiators that form free radicals. For this purpose, it is possible to use all customary peroxo and azo compounds in the amounts customarily used, e.g. from 0.1 to 5% by mass, based on the mass of the monomers to be polymerized. Preference is given to those polymerization initiators which are soluble in the oil phase or in the monomers. Examples thereof are t-butyl peroxyneodecanoate, t-butyl peroxypivalate, t-amyl peroxypivalate, dilauroyl peroxide, t-amyl peroxy-2-ethylhexanoate and the like.

The polymerization of the oil-in-water emulsion is usually carried out at 20 to 100° C., preferably at 40 to 90° C. The polymerization is usually carried out at atmospheric pressure, but can also take place at reduced or increased pressure, e.g. in the range from 0.5 to 20 bar. Expediently, the procedure involves emulsifying a mixture of water, protective colloid and/or emulsifiers, hydrophobic materials, polymerization initiators and monomers using a high-speed disperser to the desired droplet size of the hydrophobic material, and heating the stable emulsion while taking into consideration the decomposition temperature of the polymerization initiator. The polymerization rate here can be controlled in a known manner through the choice of temperature and the amount of polymerization initiator. After reaching the polymerization temperature, the polymerization is expediently continued for more time, e.g. 2 to 6 hours, in order to complete the conversion of the monomers.

Particular preference is given to one procedure in which the temperature of the reaction polymerizing mixture is continuously or periodically increased during the polymerization. This takes place with the help of a program with increasing temperature.

The total polymerization time can be divided into two or more periods for this purpose. The first polymerization period is characterized by a slow decomposition of the polymerization initiator. In the second polymerization period and, if appropriate, further polymerization periods, the temperature of the reaction mixture is increased in order to accelerate the decomposition of the polymerization initiators. The temperature can be increased in one step or two or more steps or continuously in a linear or nonlinear manner. The temperature difference between the start and the end of the polymerization can be up to 50° C. In general, this difference is 3 to 40° C., preferably 3 to 30° C.

The microcapsule dispersions obtained by one of the procedures described above can then be spray-dried in the usual manner. To facilitate redispersion of the spray-dried microcapsules, additional amounts of emulsifier and/or protective colloid can, if appropriate, be added to the dispersions prior to the spray-drying. Suitable emulsifiers and protective colloids are those specified above in connection with the preparation of the microcapsule dispersion. In general, the aqueous microcapsule dispersion is atomized in a stream of warm air, which is passed in cocurrent or countercurrent, preferably in cocurrent, with the spray mist. The inlet temperature of the stream of warm air is usually in the range from 100 to 200° C., preferably 120 to 160° C., and the exit temperature of the stream of air is generally in the range from 30 to 90° C., preferably 60 to 80° C. The spraying of the aqueous microcapsule dispersion can take place, for example, by means of single-substance or multisubstance nozzles or a rotating disk.

The spray-dried microcapsules are normally deposited using cyclones or filter separators.

The microcapsules obtainable in this way preferably have an average diameter in the range from 1 to 100 μm, particularly preferably from 1 to 50 μm and very particularly preferably from 1 to 30 μm.

On the basis of the intended use, a preferred range also arises for the ratio of thickness of the shell to the diameter of the capsules. Thus, preference is given to a microcapsule in which the ratio of the thickness of the shell to the diameter of the microcapsule is in the range from 0.0005 to 0.2, particularly preferably in the range from 0.005 to 0.08 and very particularly preferably from 0.015 to 0.055.

The present invention further provides a chemical composition comprising microcapsules as described above. Thus, the liquid microcapsule preparations or spray-dried microcapsules can be used in particular for the formulation of detergents or cleaners. However, they can also be used for the formulation of, for example, adhesives, paints, cosmetics, repellants and dispersions.

Particular preference is, however, given to a chemical composition which comprises at least one substance which is selected from the group consisting of surfactant, disinfectant, dye, acid, base, complexing agent, biocide, hydrotrope, thickener, builder, cobuilder, enzyme, bleach, bleach activator, corrosion inhibitors, bleach catalysts, color protective additives, color transfer inhibitors, graying inhibitors, soil release polymers, fiber protection additives, silicones, bactericides and preservatives, organic solvents, solubility promoters, dissolution improvers and perfume.

Surfactants generally consist of a hydrophobic moiety and a hydrophilic moiety. In this connection, the hydrophobic moiety generally has a chain length of from 4 to 20 carbon atoms, preferably 6 to 19 carbon atoms and particularly preferably 8 to 18 carbon atoms. The functional unit of the hydrophobic group is generally an OH group, where the alcohol may be branched or unbranched. In general, the hydrophilic moiety essentially consists of alkoxylated units (e.g. ethylene oxide (EO), propylene oxide (PO) and/or butylene oxide (BO)), where usually 2 to 30, preferably 5 to 20, of these alkoxylated units are connected together, and/or charged units such as sulfate, sulfonate, phosphate, carboxylic acids, ammonium and ammonium oxide.

Examples of anionic surfactants are: carboxylates, sulfonates, sulfofatty acid methyl esters, sulfates, phosphates. Examples of cationic surfactants are: quaternary ammonium compounds. Examples of betaine surfactants are: alkylbetaines. Examples of nonionic compounds are: alcohol alkoxylates.

Here, a “carboxylate” is understood as meaning a compound which has at least one carboxylate group in the molecule. Examples of carboxylates which can be used according to the invention are
soaps—e.g. stearates, oleates, cocoates of the alkali metals or of ammonium,
ether carboxylates—e.g. Akypo® RO 20, Akypo® RO 50, Akypo® RO 90.

A “sulfonate” is understood as meaning a compound which has at least one sulfonate group in the molecule. Examples of sulfonates which can be used according to the invention are
alkylbenzenesulfonates—e.g. Lutensit® A-LBS, Lutensit® A-LBN, Lutensit®A-LBA, Marlon® AS3, Maranil® DBS,
alkylsulfonates—e.g. Alscoap OS-14P, BIO-TERGEO AS-40, BIO-TERGE® AS-40 CG, BIO-TERGE® AS-90 Beads, Calimulse® AOS-20, Calimulse® AOS-40, Calsoft® AOS-40, Colonial® AOS-40, Elfan® OS 46, Ifrapon® AOS 38, Ifrapon® AOS 38 P, Jeenate® AOS-40, Nikkol® OS-14, Norfox® ALPHA XL, POLYSTEP® A-18, Rhodacal® A-246L, Rhodacal® LSS-40/A,
sulfonated oils, such as, for example, Turkish red oil,
olefinsulfonates,
aromatic sulfonates—e.g. Nekal® BX, Dowfax® 2A1.

Here, a “sulfofatty acid methyl ester” is understood as meaning a compound which has the following unit of the general formula (I):

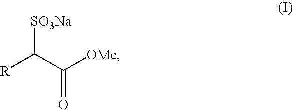

in which R has 10 to 20 carbon atoms; preferably, R has 12 to 18 and particularly preferably 14 to 16 carbon atoms.

Here, a “sulfate” is understood as meaning a compound which has at least one SO₄ group in the molecule. Examples of sulfates which can be used according to the invention are
fatty alcohol sulfates, such as, for example, coconut fatty alcohol sulfate (CAS 97375-27-4)—e.g. EMAL® 10G, Dispersogen® SI, Elfan® 280, Mackol® 100N,
other alcohol sulfates—e.g. Emal® 71, Lanette® E,
coconut fatty alcohol ether sulfate—e.g. Emal® 20C, Latemul® E150, Sulfochem® ES-7, Texapon® ASV-70 Spec., Agnique SLES-229-F, Octosol 828, POLYSTEP® B-23, Unipol® 125-E, 130-E, Unipol® ES-40,
other alcohol ether sulfates—e.g. Avanel® S-150, Avanel® S150 CG, Avanel® S150 CG N, Witcolate® D51-51, Witcolate® D51-53.

A “phosphate” is presently understood as meaning a compound which has at least one PO₄ group in the molecule. Examples of phosphates which can be used according to the invention are
alkyl ether phosphates—e.g. Maphos® 37P, Maphos® 54P, Maphos® 37T, Maphos® 210T and Maphos® 210P,
phosphates such as Lutensit A-EP,
phosphates.

In the preparation of the chemical composition, the anionic surfactants are preferably added in the form of salts. Suitable salts here are, for example, alkali metal salts, such as sodium, potassium and lithium salts, and ammonium salts, such as hydroxyethylammonium, di(hydroxyethyl)ammonium and tri(hydroxyethyl)ammonium salts.

A “quaternary ammonium compound” is understood as meaning a compound which has at least one R₄N⁺ group in the molecule. Examples of quaternary ammonium compounds which can be used according to the invention are
halides, methosulfates, sulfates and carbonates of coconut fat, tallow fat or cetyl/oleyltrimethylammonium.

Particularly suitable cationic surfactants that may be mentioned are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines which are esterified with C₈-C₂₂-carboxylic acids;
imidazoline quats, in particular 1-alkylimidazolinium salts of the formulae II or III

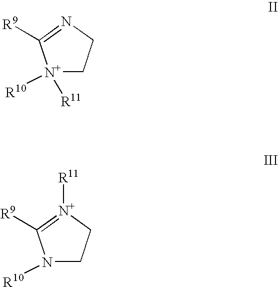

in which the variables have the following meaning:
R⁹ C₁-C₂₅-alkyl or C₂-C₂₅-alkenyl;
R¹⁰ C₁-C₄-alkyl or hydroxy-C₁-C₄-alkyl;
R¹¹ C₁-C₄-alkyl, hydroxy-C₁-C₄-alkyl or a radical R¹—(CO)—X—(CH₂)ₘ— (X: —O— or —NH—; m: 2 or 3),
where at least one radical R⁹ is C₇-C₂₂-alkyl.

Furthermore, a “betaine surfactant” is understood as meaning a compound which, under application conditions, i.e. for example in the case of textile washing under standard pressure and at temperatures from room temperature to 95° C., carries at least one positive charge and at least one negative charge. An “alkylbetaine” here is a betaine surfactant which has at least one alkyl unit in the molecule. Examples of betaine surfactants which can be used according to the invention are cocamidopropylbetaine—e.g. MAFO® CAB, Amonyl® 380 BA, AMPHOSOL® CA, AMPHOSOL® CG, AMPHOSOL® CR, AMPHOSOL® HCG; AMPHOSOL® HCG-50, Chembetaine® C, Chembetaine® CGF, Chembetaine® CL, Dehyton® PK, Dehyton® PK 45, Emery® 6744, Empigen® BS/F, Empigen® BS/FA, Empigen® BS/P, Genagen® CAB, Lonzaine® C, Lonzaine® CO, Mirataine® BET-C-30, Mirataine® CB, Monateric® CAB, Naxaine® C, Naxaine® CO, Norfox® CAPB, Norfox® Coco Betaine, Ralufon® 414, TEGO®-Betain CKD, TEGO® Betain E KE 1, TEGO®-Betain F, TEGO®-Betain F 50 and amine oxides, such as, for example, alkyldimethylamine oxides, i.e. compounds of the general formula (IV)

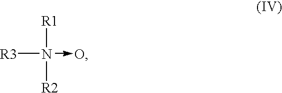

in which R1, R2 and R3, independently of one another, are an aliphatic, cyclic or tertiary alkyl or amidoalkyl radical, such as, for example, Mazox® LDA, Genaminox®, Aromox® 14 DW 970.

Nonionic surfactants are interface-active substances with an uncharged polar, hydrophilic, water-solubilizing head group which carries no ionic charge in the neutral pH range (in contrast to anionic and cationic surfactants), which adsorbs at interfaces and aggregates above the critical micelle concentration (cmc) to give neutral micelles. Depending on the nature of the hydrophilic head group, a distinction can be made between (oligo)oxyalkylene groups, in particular (oligo)oxyethylene groups (polyethylene glycol groups), which include the fatty alcohol polyglycol ethers (fatty alcohol alkoxylates), alkylphenol polyglycol ethers, and fatty acid ethoxylates, alkoxylated triglycerides and mixed ethers (polyethylene glycol ethers alkylated at both ends); and carbohydrate groups, which include, for example, the alkyl polyglucosides and fatty acid N-methylglucamides.

Alcohol alkoxides are based on a hydrophobic moiety with a chain length of from 4 to 20 carbon atoms, preferably 6 to 19 carbon atoms and particularly preferably 8 to 18 carbon atoms, where the alcohol may be branched or unbranched, and a hydrophilic moiety, which may be alkoxylated units, e.g. ethylene oxide (EO), propylene oxide (PO) and/or butylene oxide (BuO) having 2 to 30 repeat units. Examples are inter alia Lutensol® XP, Lutensol® XL, Lutensol® ON, Lutensol® AT, Lutensol® A, Lutensol® AO, Lutensol® TO.

Alcohol phenol alkoxylates are compounds of the general formula (V),

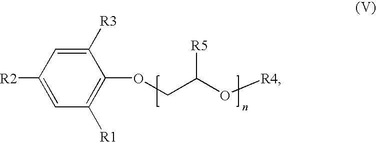

which are prepared by the addition reaction of alkylene oxide, preferably of ethylene oxide, onto alkylphenols. Preferably here R4=H. Moreover, it is preferred if R5=H,—it is thus EO; it is likewise preferred if R5=CH₃, it is thus PO, or, if R5=CH₂CH₃ and it is BuO. Moreover, particular preference is given to a compound in which octyl-[(R1=R3=H, R2=1,1,3,3-tetramethylbutyl(isobutylene)], nonyl-[(R1=R3=H, R2=1,3,5-trimethylhexyl(tripropylene)], dodecyl-, dinonyl- or tributylphenol polyglycol ethers (e.g. EO, PO, BuO), R—C₆H₄—O-(EO/PO/BuO)ₙ where R=C8 to C12 and n=5 to 10, are present. Nonexhaustive examples of such compounds are: Norfox® OP-102, Surfonic® OP-120, T-Det® O-12.

Fatty acid ethoxylates are fatty acid esters aftertreated with varying amounts of ethylene oxide (EO).

Triglycerides are esters of glycerol (glycerides) in which all three hydroxyl groups are esterified with fatty acids. These can be modified with alkylene oxide.

Fatty acid alkanolamides are compounds of the general formula (VI)

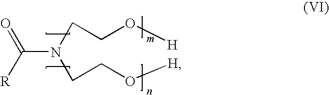

which has at least one amide group with an alkyl radical R and one or two alkoxy radical(s), where R comprises 11 to 17 carbon atoms and 1≦m+n≦5.

Alkyl polyglycosides are mixtures of alkyl monoglucoside (alkyl-α-D- and -β-D-gluco-pyranoside and small fractions of -glucofuranoside), alkyl diglucosides (-isomaltosides, -maltosides and others) and alkyl oligoglucosides (-maltotriosides, -tetraosides and others). Alkyl polyglycosides are accessible inter alia through acid-catalyzed reaction (Fischer reaction) from glucose (or starch) or from n-butyl glucosides with fatty alcohols. Alkyl polyglycosides correspond to the general formula (VII)

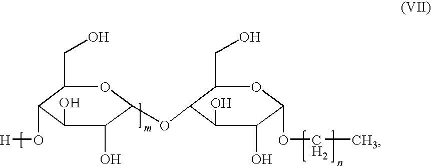

in which
m=0 to 3 and
n=4 to 20.

One example is Lutensol® GD70.

In the group of nonionic N-alkylated, preferably N-methylated, fatty acid amides of the general formula (VIII)

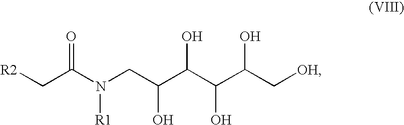

R1 is an n-C₁₋₂-alkyl radical, R2 is an alkyl radical having 1 to 8 carbon atoms. R2 is preferably methyl.

A composition as described which moreover comprises at least one disinfectant is particularly preferred. In this connection, the at least one disinfectant is present in the composition in a (total) amount of from 0.1 to 20 mass %, preferably from 1 to 10 mass %.

Disinfectants may be: oxidizing agents, halogens such as chlorine and iodine and substances releasing these, alcohols, such as ethanol, 1-propanol and 2-propanol, aldehydes, phenols, ethylene oxide, chlorhexidine and mecetronium metilsulfate.

The advantage of the use of disinfectants consists in the fact that pathogens are hardly able to spread on the treated surface. Pathogens may be: bacteria, spores, fungi and viruses.

Dyes can be inter alia: Acid Blue 9, Acid Yellow 3, Acid Yellow 23, Acid Yellow 73, Pigment Yellow 101, Acid Green 1, Acid Green 25.

Preference is given to a composition in which the at least one dye is present in a (total) amount of from 0.1 to 20% by mass, particularly preferably from 1 to 10% by mass.

Acids are compounds which are advantageously used, for example, for dissolving and/or for preventing limescale deposits. Examples of acids are formic acid, acetic acid, citric acid, hydrochloric acid, sulfuric acid and sulfonic acid.

Bases are compounds which can advantageously be used for establishing the favorable pH range for complexing agents. Examples of bases which can be used according to the invention are: NaOH, KOH and aminoethanol.

Suitable inorganic builders are, in particular:
crystalline and amorphous alumosilicates with ion-exchanging properties, such as in particular zeolites: various types of zeolites are suitable, in particular the zeolites A, X, B, P, MAP and HS in their Na form or in forms in which Na is partially exchanged for other cations such as Li, K, Ca, Mg or ammonium;
crystalline silicates, such as in particular disilicates and sheet silicates, e.g. δ- and β-Na₂Si2O₅. The silicates can be used in the form of their alkali metal, alkaline earth metal or ammonium salts, preference being given to the Na, Li and Mg silicates;
amorphous silicates, such as sodium metasilicate and amorphous disilicate;
carbonates and hydrogencarbonates: these can be used in the form of their alkali metal, alkaline earth metal or ammonium salts. Preference is given to Na, Li and Mg carbonates and hydrogencarbonates, in particular sodium carbonate and/or sodium hydrogencarbonate; and
polyphosphates, such as pentasodium triphosphate.

Suitable oligomeric and polymeric cobuilders are:

oligomeric and polymeric carboxylic acids, such as homopolymers of acrylic acid and aspartic acid, oligomaleic acids, copolymers of maleic acid with acrylic acid, methacrylic acid or C₂-C₂₂-olefins, e.g. isobutene or long-chain α-olefins, vinyl-C₁-C₈-alkyl ethers, vinyl acetate, vinyl propionate, (meth)acrylic acid esters of C₁-C₈-alcohols and styrene. Preference is given to the homopolymers of acrylic acid and copolymers of acrylic acid with maleic acid. The oligomeric and polymeric carboxylic acids are used in acid form or as sodium salt.

Complexing agents are compounds which are able to bind cations. This can be utilized in order to reduce the hardness of water and to precipitate out troublesome heavy metal ions. Examples of complexing agents are NTA, EDTA, MGDA, DTPA, DTPMP, IDS, HEDP, β-ADA, GLDA, citric acid, oxydisuccinic acid and butanetetracarboxylic acid. The advantage of using these compounds is that many cleaning-active compounds achieve a better effect in soft water; moreover, by reducing the water hardness, the formation of limescale deposits after cleaning can be avoided. Using these compounds therefore dispenses with the need to dry a cleaned surface. From the point of view of the operating sequence, this is advantageous and in particular therefore desirable since, in this way, the composition according to the invention applied for preservation is not partially removed again. In the case of the treatment of textiles, the fibers remain more mobile, thus giving rise to a better wear feel.

Suitable graying inhibitors are, for example, carboxymethylcellulose and graft polymers of vinyl acetate onto polyethylene glycol.

Suitable bleaches are, for example, adducts of hydrogen peroxide onto inorganic salts, such as sodium perborate monohydrate, sodium perborate tetrahydrate and sodium carbonate perhydrate, and percarboxylic acid, such as phthalimidopercaproic acid.

Suitable bleach activators are, for example, N,N,N′,N′-tetraacetylethylenediamine (TAED), sodium p-nonanoyloxybenzenesulfonate and N-methylmorpholinium acetonitrile methyl sulfate.

Suitable enzymes are, for example, proteases, lipases, amylases, cellulases, mannanases, oxidases and peroxidases.

Suitable color transfer inhibitors are, for example, homopolymers, copolymers and graft polymers of 1-vinylpyrrolidone, 1-vinylimidazole and 4-vinylpyridine N-oxide. Homopolymers and copolymers of 4-vinylpyridine reacted with chloroacetic acid are also suitable as color transfer inhibitors.

Biocides are compounds which kill bacteria. One example of a biocide is glutar-aldehyde. The advantage of using biocides is that they counteract the spread of pathogens.

Hydrotropes are compounds which improve the solubility of the surfactant/surfactants in the chemical composition. One example of a hydrotrope is: cumene sulfonate.

Thickeners are compounds which increase the viscosity of the chemical composition. Nonlimiting examples of thickeners are: polyacrylates and hydrophobically modified polyacrylates. The advantage of using thickeners is that liquids of relatively high viscosity have a longer residence time on inclined or vertical surfaces than liquids of lower viscosity. This increases the interaction time between composition and surface to be cleaned.

The use of the microcapsules according to the invention for producing the chemical composition according to the invention forms a further subject matter of the invention.

The present invention further provides the use of microcapsules according to the invention for treating surfaces. Preference is given here to a use in which the surface to be treated is selected from the group consisting of fibers, nonwovens, foams, tiles, marble, ceramic, concrete, plastic, metal, enamel, glass. Particular preference is given to a use in which the article to be treated is a textile.

The use of microcapsules according to the invention and in particular the use of a chemical composition comprising microcapsules according to the invention in textile washing is therefore also a particularly preferred subject matter of the present invention.

The present invention further provides an article which has microcapsules according to the invention and preference is given to an article which has the microcapsules according to the invention on its surface.

Here, a suitable article is any body for which it is desired that it releases a certain odor upon contact, i.e. upon being subjected to pressure. Nonexhaustive examples are: packaging materials of all types such as cardboard, film, adhesive, adhesive labels, cleansing wipes, nonwovens, leather products, paints and coatings, cosmetic products, any type of containers, in particular those which comprise foods or cosmetics, glass, plastic components, automobiles etc.

The invention is described in more detail below by examples:

### EXAMPLES

### Example 1

### Comparative Example

Only bifunctional crosslinker: 1,4-butanediol diacrylate

The following mixture

of water phase

| | | |
|---|---|---|
| 409.45 | g | water |
| 416.5 | g | polyvinyl alcohol [Mowiol ® 40/88 (10% in water)] |
| 1.91 | g | NaNO₂ |

and oil phase

| | | |
|---|---|---|
| 46.2 | g | methyl methacrylate |
| 44.55 | g | 1,4-butanediol diacrylate |
| 9.25 | g | dimethylaminoethyl methacrylate |
| 1.55 | g | 2-ethyl thioglyconate |
| 100 | g | citral (CAS No. 5392-40-5) |
| 300 | g | white oil (CAS No. 8042-47-5) |

was placed (total amount 1362.5 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.33 g of tert-butyl perpivalate (75% strength solution in isododecane) and, for rinsing, 1.15 g of water were added and the reactor was heated to 70° C. over the course of 1 hour. The reactor contents were then heated to 85° C. over 1 hour and then held at this temperature for 1 hour. 4.89 g of a 10% strength aqueous solution of tert-butyl hydroperoxide were added and the reactor was cooled to 25° C. over the course of 90 minutes, during which, over the course of the first 80 minutes, a solution of 0.27 g of ascorbic acid in 25.4 g of water was metered in.

The solids content of this dispersion was 37.6%, with an average particle size of 2.179 μm (determined by means of light scattering).

### Example 2

### Comparative Example

Only tetrafunctional crosslinker: Pentaerythritol tetraacrylate

The following mixture

of water phase

| | | |
|---|---|---|
| 409.45 | g | water |
| 416.5 | g | polyvinyl alcohol [Mowiol ® 40/88 (10% in water)] |
| 1.91 | g | NaNO₂ |

and oil phase

| | | |
|---|---|---|
| 46.2 | g | methyl methacrylate |
| 9.25 | g | dimethylaminoethyl methacrylate |
| 40 | g | pentaerythritol tetraacrylate |
| 1.55 | g | 2-ethyl thioglyconate |
| 100 | g | citral (CAS No. 5392-40-5) |
| 300 | g | white oil (CAS No. 8042-47-5) |

was placed (total amount 1362.5 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.33 g of tert-butyl perpivalate (75% strength solution in isododecane) and, for rinsing, 1.15 g of water were added and the reactor was heated to 70° C. over the course of 1 hour. The reactor contents were then heated to 85° C. over 1 hour and then held at this temperature for 1 hour. 4.89 g of a 10% strength aqueous solution of tert-butyl hydroperoxide were added and the reactor was cooled to 25° C. over the course of 90 minutes, during which, over the course of the first 80 minutes, a solution of 0.27 g of ascorbic acid in 25.4 g of water was metered in.

The solids content of this dispersion was 37.8%, with an average particle size of 2.737 μm (determined by means of light scattering).

### Example 3

Crosslinker mixture: Bi- and tetrafunctional crosslinker: 1,4-Butanediol diacrylate & pentaerythritol tetracrylate

The following mixture

of water phase

| | | |
|---|---|---|
| 328.45 | g | water |
| 333.2 | g | polyvinyl alcohol [Mowiol ® 40/88 (10% in water)] |
| 1.53 | g | NaNO₂ |

and oil phase

| | | |
|---|---|---|
| 40 | g | methyl methacrylate |
| 24 | g | 1,4-butanediol diacrylate |
| 8 | g | dimethylaminoethyl methacrylate |
| 8 | g | pentaerythritol tetraacrylate |
| 1.24 | g | 2-ethyl thioglyconate |
| 80 | g | citral (CAS No. 5392-40-5) |
| 240 | g | white oil (CAS No. 8042-47-5) |

was placed (total amount 1090 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.06 g of tert-butyl perpivalate (75% strength solution in isododecane) and, for rinsing, 1.15 g of water were added and the reactor was heated to 70° C. over the course of 1 hour. The reactor contents were then heated to 85° C. over 1 hour and then held at this temperature for 1 hour. 3.91 g of a 10% strength aqueous solution of tert-butyl hydroperoxide were added and the reactor was cooled to 25° C. over the course of 90 minutes, during which, over the course of the first 80 minutes, a solution of 0.22 g of ascorbic acid in 20.3 g of water was metered in.

The solids content of this dispersion was 37.8% with an average particle size of 2.737 μm (determined by means of light scattering).

### Example 4

### Analysis of the Release Behavior

The finished dispersions from examples 1 to 3 were painted onto a carton using a knife. The scent impression was assessed sensorily before and after rubbing with the finger (cf. evaluation scale).

### Definition of the Evaluation Scale:

| Number | Evaluation |
|---|---|
| 1 | Very slight odor perception |
| 2 | Marked odor perception |
| 3 | Strong odor perception |

### Before the Rubbing Experiment

| Example | 1 week | 2 weeks | 2 months |
|---|---|---|---|
| 1 | 2 | 1 | 1 |
| 2 | 2 | 1 | 1 |
| 3 | 1-2 | 1 | 1 |

### After the Rubbing Experiment

| Example | 1 Week | 1 month | 2 months |
|---|---|---|---|
| 1 | 3 | 1-2 | 1 |
| 2 | 3 | 1-2 | 1 |
| 3 | 3 | 2 | 2 |

It is clearly evident that the product according to the invention has improved scent release upon prolonged storage.

Further examples for the encapsulation of scents and fragrances:

### Example 5

The following mixture

of water phase

| | | |
|---|---|---|
| 592 | g | water |
| 190 | g | modified cellulose [Culminal MHPC 100 (5% in water)] |
| 47.5 | g | polyvinyl alcohol [Mowiol ® 15/79 (10% in water)] |
| 2.1 | g | NaNO₂ |

and oil phase

| | | |
|---|---|---|
| 55.0 | g | methyl methacrylate |
| 33 | g | 1,4-butanediol diacrylate |
| 11 | g | dimethylaminoethyl methacrylate |
| 11 | g | pentaerythritol triacrylate |
| 1.7 | g | 2-ethyl thioglyconate |
| 110 | g | citral (CAS No. 5392-40-5) |
| 330 | g | white oil (CAS No. 8042-47-5) |

was placed (total amount 1431.68 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.46 g of tert-butyl perpivalate (75% strength solution in isododecane) and, for rinsing, 1.26 g of water were added and the reactor was heated to 70° C. over the course of 1 hour. The reactor contents were then heated to 85° C. over 1 hour and then held at this temperature for 1 hour. 5.38 g of a 10% strength aqueous solution of tert-butyl hydroperoxide were then added and the reactor was cooled to 25° C. over the course of 90 minutes, during which, over the course of the first 80 minutes, a solution of 0.14 g of ascorbic acid in 20 g of water was metered in.

The dispersion prepared in this way was treated, for stabilization, with 0.65 g of Acticide MBS and 0.72 g of Actizide MV. To adjust the rheology, 6.7 g of a thickener (Viscalex HV 30®) were added, and the pH was adjusted to pH=8 by adding sodium hydroxide solution (17% strength)

The solids content of this dispersion was 37.6% with an average particle size of 5.567 μm (determined by means of light scattering).

### Example 6

The following mixture

of water phase

| | | |
|---|---|---|
| 592 | g | water |
| 190 | g | modified cellulose [Culminal MHPC 100 (5% in water)] |
| 47.5 | g | polyvinyl alcohol [Mowiol ® 15/79 (10% in water)] |
| 2.1 | g | NaNO₂ |

and oil phase

| | | |
|---|---|---|
| 55.0 | g | methyl methacrylate |
| 33 | g | 1,4-butanediol diacrylate |
| 11 | g | dimethylaminoethyl methacrylate |
| 11 | g | pentaerythritol triacrylate |
| 1.7 | g | 2-ethyl thioglyconate |
| 110 | g | scent mixture for detergents and cleaners |
| 330 | g | white oil (CAS No. 8042-47-5) |

was placed (total amount 1431.68 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.46 g of tert-butyl perpivalate (75% strength solution in isododecane and, for rinsing, 1.26 g of water were added and the reactor was heated to 70° C. over the course of 1 hour. The reactor contents were then heated to 85° C. over 1 hour and then held at this temperature for 1 hour. 5.38 g of a 10% strength aqueous solution of tert-butyl hydroperoxide were then added and the reactor was cooled to 25° C. over the course of 90 minutes, during which, over the course of the first 80 minutes, a solution of 0.3 g of ascorbic acid in 28 g of water was metered in.

The dispersion prepared in this way was treated, for stabilization, with 0.65 g of Acticide MBS and 0.72 g of Actizide MV. To adjust the rheology, 6.7 g of a thickener (Viscalex HV 30®) were added and the pH was adjusted to pH=8 by adding sodium hydroxide solution (17% strength).

The solids content of this dispersion was 36.8% with an average particle size of 5.448 μm (determined by means of light scattering).

### Example 7

The following mixture

of water phase

| | | |
|---|---|---|
| 216.62 | g | water |
| 95.15 | g | modified cellulose [Culminal MHPC 100 (5% in water)] |
| 23.65 | g | polyvinyl alcohol [Mowiol ® 15/79 (10% in water)] |
| 1.1 | g | NaNO₂ |

and oil phase

| | | |
|---|---|---|
| 22.0 | g | methyl methacrylate |
| 16.5 | g | 1,4-butanediol diacrylate |
| 11 | g | methacrylic acid |
| 5.5 | g | pentaerythritol triacrylate |
| 55 | g | scent mixture for detergents and cleaners |
| 165 | g | white oil (CAS No. 8042-47-5) |

was placed (total amount 629.14 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 0.73 g of tert-butyl perpivalate (75% strength solution in isododecane) and, for rinsing, 1 g of water were added and the reactor was heated to 70° C. over the course of 1 hour. The reactor contents were then heated to 85° C. over 1 hour, and then held at this temperature for 1 hour. 2.75 g of a 10% strength aqueous solution of tert-butyl hydroperoxide were then added and the reactor was cooled to 25° C. over the course of 90 minutes, during which, over the course of the first 80 minutes, a solution of 0.14 g of ascorbic acid in 14 g of water was metered in.

The solids content of this dispersion was 41.1% with an average particle size of 2.264 μm (determined by means of light scattering).

### Example 8

The following mixture

of water phase

| | | |
|---|---|---|
| 427.12 | g | water |
| 138.4 | g | modified cellulose [Culminal MHPC 100 (5% in water)] |
| 34.4 | g | polyvinyl alcohol [Mowiol ® 15/79 (10% in water)] |
| 1.53 | g | NaNO₂ |

and oil phase

| | | |
|---|---|---|
| 40.0 | g | methyl methacrylate |
| 24 | g | 1,4-butanediol diacrylate |
| 8 | g | dimethylaminomethyl methacrylate |
| 8 | g | pentaerythritol triacrylate |
| 1.24 | g | 2-ethylhexyl thioglycolate |
| 80 | g | scent mixture for detergents and cleaners |
| 240 | g | white oil (CAS No. 8042-47-5) |

was placed (total amount 1003 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 0.8 g of tert-butyl perneodecanoate and, for rinsing, 1 g of water were added and the reactor was heated to 50° C. over the course of 1 hour. The reactor contents were then heated to 70° C. over 1 hour and then held at this temperature for 1 hour. 3.91 g of a 10% strength aqueous solution of tert-butyl hydroperoxide were then added and the reactor was cooled to 25° C. over the course of 90 minutes, during which, over the course of the first 80 minutes, a solution of 0.22 g of ascorbic acid in 25 g of water was metered in.

The solids content of this dispersion was 33.6% with an average particle size of 2.27 μm (determined by means of light scattering).

### Example 9

The following mixture

of water phase

| | | |
|---|---|---|
| 359.6 | g | water |
| 172.02 | g | modified cellulose [Culminal MHPC 100 (5% in water)] |
| 86.01 | g | polyvinyl alcohol [Mowiol ® 15/79 (10% in water)] |
| 1.58 | g | NaNO2 |

and oil phase

| | | |
|---|---|---|
| 40.51 | g | methyl methacrylate |
| 25.8 | g | 1,4-butanediol diacrylate |
| 8.6 | g | dimethylaminomethyl methacrylate |
| 8.6 | g | pentaerythritol triacrylate |
| 1.33 | g | 2-ethylhexyl thioglycolate |
| 86.01 | g | scent mixture for detergents and cleaners |
| 258.02 | g | C12-15 benzoic acid alkyl esters (CAS 68411-27-8) |

was placed (total amount 1049 g) into a 2 l reactor with dispenser stirrer (diameter cm);

The mixture was dispersed for 40 minutes at room temperature at a speed of 3500 rpm and then transferred to a 2 l reactor equipped with an anchor stirrer. 0.86 g of tert-butyl perneodecanoate and, for rinsing, 1 g of water were added and the reactor was heated to 50° C. over the course of 1 hour. The reactor contents were then heated to 70° C. over 1 hour, and then held at this temperature for 1 hour. 4.3 g of a 10% strength aqueous solution of tert-butyl hydroperoxide were then added and the reactor was cooled to 25° C. over the course of 90 minutes, during which, over the course of the first 80 minutes, a solution of 0.23 g of ascorbic acid in 21 g of water was metered in.

The solids content of this dispersion was 39.8% with an average particle size of 2.89 μm (determined by means of light scattering).

### Example 10

The following mixture

of water phase

| | | |
|---|---|---|
| 268.07 | g | water |
| 128 | g | modified cellulose [Culminal MHPC 100 (5% in water)] |
| 64 | g | polyvinyl alcohol [Mowiol ® 15/79 (10% in water)] |
| 1.22 | g | NaNO2 |

and oil phase

| | | |
|---|---|---|
| 30.14 | g | methyl methacrylate |
| 19.2 | g | 1,4-butanediol diacrylate |
| 6.4 | g | dimethylaminomethyl methacrylate |
| 6.4 | g | pentaerythritol triacrylate |
| 0.99 | g | 2-ethylhexyl thioglycolate |
| 102.4 | g | scent mixture for detergents and cleaners |
| 153.6 | g | C12-15 benzoic acid alkyl esters (CAS 68411-27-8) |

was placed (total amount 780 g) into a 2 l reactor with dispenser stirrer (diameter 5 cm).

The mixture was dispersed for 40 minutes at room temperature at a speed of 3500 rpm and then transferred to a 2 l reactor equipped with an anchor stirrer. 1.28 g of tert-butyl perneodecanoate and, for rinsing, 1 g of water were added and the reactor was heated to 50° C. over the course of 1 hour. The reactor contents were then heated to 70° C. over 1 hour, and then held at this temperature for 1 hour. 3.2 g of a 10% strength aqueous solution of tert-butyl hydroperoxide were then added and the reactor was cooled to 25° C. over the course of 90 minutes, during which, over the course of the first 80 minutes, a solution of 0.17 g of ascorbic acid in 18.6 g of water was metered in.

The solids content of this dispersion was 37% with an average particle size of 2.18 μm (determined by means of light scattering).

1. A microcapsule comprising a core a), which comprises a scent or fragrance, and a shell b), where b) is obtainable by the polymerization of
one or more C₁-C₂₄-alkyl ester(s) of acrylic acid and/or methacrylic acid and
at least two different bi- or polyfunctional monomers.

2. The microcapsule according to claim 1, in which, independently of one another,
a) comprises at least one hydrophobic material,
b) can be prepared by free-radical polymerization,
the amount of C₁-C₂₄-alkyl ester(s) of acrylic acid and/or methacrylic acid in the microcapsule is 1 to 99.99% by mass,
a C₁-C₁₈-alkyl ester(s) of acrylic acid and/or methacrylic acid is present,
the amount of the at least two different bi- or polyfunctional monomers in the microcapsule is 0.01 to 70% by mass,
two, three, four or five different monomers with free-radically polymerizable groups are present,
the amount of monofunctional vinylic monomers which have additional nonvinylic functional groups in the microcapsule is 0 to 50% by mass, and
further monofunctional monomers which have additional nonvinylic functional groups are present in an amount of from 0 to 40% by mass in the microcapsule.

3. The microcapsule according to claim 1, in which, independently of one another,
a) consists of the at least one hydrophobic material and the at least one scent or fragrance or
a) consists of the at least one scent or fragrance,
b) is prepared by free-radical polymerization,
the amount of C₁-C₂₄-alkyl ester(s) of acrylic acid and/or methacrylic acid in the microcapsule is 20 to 80% by mass,
a C₁-C₁₂-alkyl ester(s) of acrylic acid and/or methacrylic acid is present,
the amount of the at least two different bi- or polyfunctional monomers in the microcapsule is 5 to 50% by mass,
two or three different monomers with di- or polyunsaturated and free-radically polymerizable groups are present,
the amount of monofunctional vinylic monomers which have additional nonvinylic functional groups in the microcapsule is 10 to 40% by mass, and
further monofunctional monomers which have additional nonvinylic functional groups are present in the microcapsule in an amount of from 5 to 35% by mass.

4. The microcapsule according to claim 2, in which, independently of one another,
the at least one hydrophobic material is selected from the group consisting of: vegetable oil, animal oil, low-viscosity hydrophobic materials and mineral oil,
the at least one scent or fragrance is selected from the group consisting of: natural scents or fragrances, synthetic scents or fragrances and semisynthetic scents or fragrances,
the amount of C₁-C₂₄-alkyl ester(s) of acrylic acid and/or methacrylic acid in the microcapsule is 40 to 60% by mass,
a C₁-C₆-alkyl ester(s) of acrylic acid and/or methacrylic acid is present,
the amount of the at least two different bi- or polyfunctional monomers in the microcapsule is 20 to 40% by mass,
two different monomers with di- or polyunsaturated and free-radically polymerizable groups are present,
the amount of monofunctional vinylic monomers which have additional nonvinylic functional groups in the microcapsule is 20 to 30% by mass, and
further monofunctional monomers which have additional nonvinylic functional groups are present in the microcapsule in an amount of from 10 to 30% by mass.

5. The microcapsule according to claim 1, in which the average diameter is in the range from 0.8 to 100 μm.

6. The microcapsule according claim 1, in which the ratio of the thickness of the shell to the diameter of the microcapsule is in the range from 0.005 to 0.1.

7. A chemical composition comprising microcapsules according to claim 1.

8. The chemical composition according to claim 7, which comprises at least one substance which is selected from the group consisting of surfactant, disinfectant, dye, acid, base, complexing agent, biocide, hydrotrope, thickener, builder, cobuilder, enzyme, bleach, bleach activator, corrosion inhibitors, bleach catalysts, color protection additives, color transfer inhibitors, graying inhibitors, soil release polymers, fiber protection additives, silicones, bactericides and preservatives, organic solvents, solubility promoters, dissolution improvers and perfume.

9-12. (canceled)

13. An article which comprises microcapsules according to claim 1.

14. The article according to claim 13, which has the microcapsules on its surface.

15. A method for treating surfaces comprising applying to said surfaces a chemical composition according to claim 7.

16. A method of washing textiles comprising treating said textiles with a chemical composition according to claim 7.
